(19) United States
(12) Patent Application Publication
(10) Pub. No.: US 2001/0020842 A1
(43) Pub. Date: Sep. 13, 2001

(54) VOLTAGE REGULATOR

(76) Inventor: MITCHEL BECK, PHOENIX, AR (US)

Correspondence Address: BLAKELY SOKOLOFF TAYLOR & ZAFMAN, 12400 WILSHIRE BOULEVARD, 7TH FLOOR, LOS ANGELES, CA, 90025

(21) Appl. No.: 09/239,624

(22) Filed: Jan. 28, 1999

(51) Int. Cl. G05F 3/04; G05F 3/08

(52) U.S. Cl. 323/314

(57) ABSTRACT

Briefly, in accordance with one embodiment of the invention, an integrated circuit includes: a voltage regulator, the voltage regulator having the capability to both sink and source current while maintaining a substantially predetermined voltage level.

### RELATED APPLICATION

This patent application is related to concurrently filed U.S. patent application Ser. No. ______, titled “Transceiver,” (attorney docket 042390.P6650), by M. Beck, filed ______, assigned to the assignee of the present invention and herein incorporated by reference.

### BACKGROUND

1. Field

The present invention is related to voltage regulators.

2. Background Information

Voltage regulators are well-known in the art and serve a variety of purposes. Typically, voltage regulators are employed to maintain a substantially constant voltage level for a circuit. Typically, such voltage regulators either sink current or source current. In some environments, it may also be desirable to have a voltage regulator that has the capability to switch modes of operation, depending on a variety of factors.

### SUMMARY

Briefly, in accordance with one embodiment of the invention, an integrated circuit includes: a voltage regulator, the voltage regulator having the capability to both sink and source current while maintaining a substantially predetermined voltage level.

### BRIEF DESCRIPTION OF THE DRAWINGS

The subject matter regarded as the invention is particularly pointed out and distinctly claimed in the concluding portions of this specification. The invention, however, both as to organization and method of operation, together with objects, features, and advantages thereof, may best be understood by reference to the following detailed description, when read with the accompanying drawings in which:

FIG. 1 is a circuit diagram illustrating an embodiment of a voltage regulator in accordance with the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the aforementioned concurrently filed patent application, Ser No. ______ (attorney docket 042390.P6650), a voltage regulator is described as part of an embodiment of a transceiver. It will be understood that an embodiment of a voltage regulator in accordance with the present invention may be employed in this fashion; however, the present invention is not limited in scope to use in this respect. For the particular voltage regulator embodiment described in the aforementioned concurrently filed patent application Ser. No. ______ (attorney docket 042390.P6650), pins are provided that couple parallel terminations to the voltage regulator providing parallel far end termination for an upstream transceiver and near end termination for a downstream transceiver. In the embodiment illustrated, when the voltage regulator is operational, it provides a relatively low impedance in series with the coupled parallel termination impedances. In an alternative mode, however, the voltage regulator, designated 275, may provide a relatively high impedance. This effectively switches out or disables the parallel termination. As described in the aforementioned patent application, this mode of operation for voltage regulator 275 may be desirable when full speed or low speed communication signal operation is desired for the transceiver.

The effect of providing a voltage regulator with these two modes allows for two different signaling techniques, such as, voltage driven signaling and current driven signaling, to be employed transparently. When the voltage regulator is operational, providing a relatively low impedance, this allows the appropriate termination to perform current mode signaling, so that high speed signal communication may occur. Alternatively, when the voltage regulator provides a relatively high impedance, this allows for voltage mode signaling to take place, as is traditionally employed, for example, in circuits and other devices that comply with the Universal Serial Bus (USB) specification, version 1.0, available from USB-IF, 2111 NE 25^{th} Ave., MS-JF2-51, Hillsboro, Oreg. 97124 (hereinafter referred to as “standard USB”). Thus, this voltage regulator embodiment further provides the capability for self-configurability in this transceiver environment.

In addition to providing the capability to disable the parallel termination, as previously described, an embodiment of a voltage regulator in accordance with the invention, such as voltage regulator 275 in the aforementioned concurrently filed patent application, may also both sink and source current when high speed communication is occurring, while maintaining a substantially constant voltage level. In this context, “both sink and source current” refers to the capability to offset an amount of current being received by also delivering that amount of current, although, the particular order in which this reception and delivery occurs is not significant. Maintaining a substantially constant voltage level may be desirable, such as, for example, to maintain the voltage level of a driver at a voltage level above ground so that it may operate satisfactorily, such as, for example, a high speed receiver in the aforementioned concurrently filed patent application.

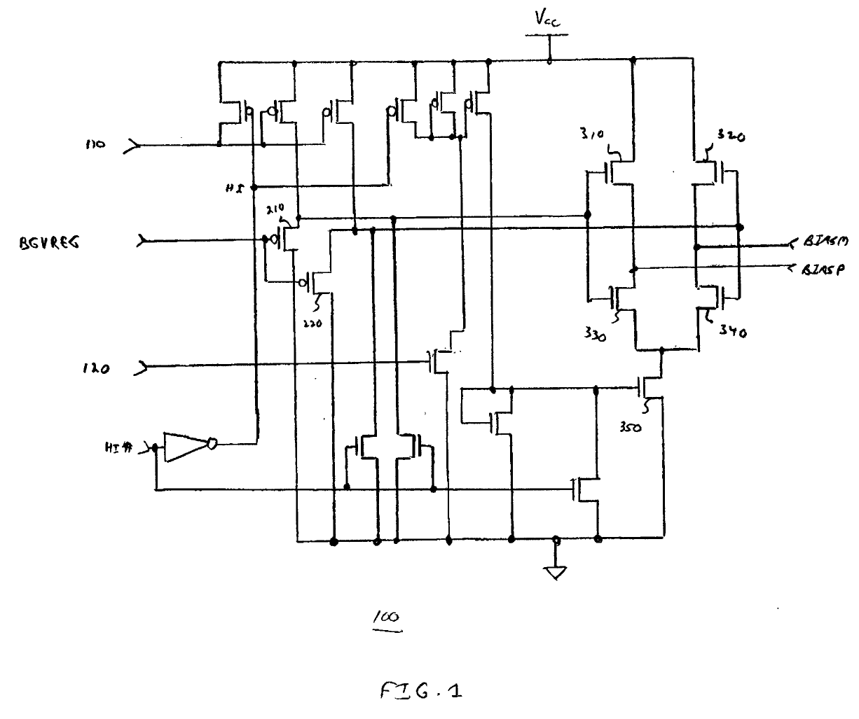

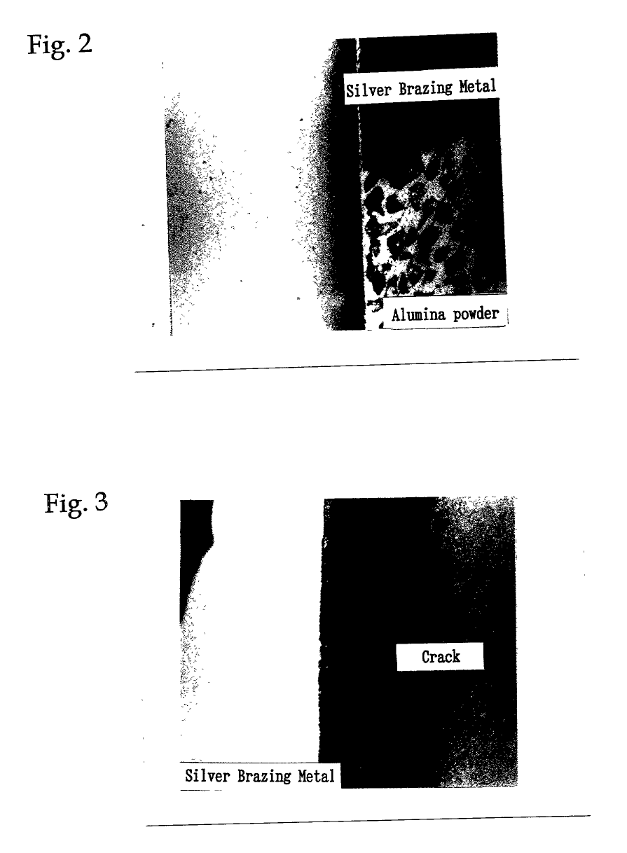

Of course, an embodiment of a voltage regulator in accordance with the invention is not limited in scope to be used in this manner. Such a voltage regulator may have many applications other than the use with a transceiver, as described in the concurrently filed patent application Ser. No. ______ (attorney docket 042390.P6650). Therefore, although this particular embodiment of a voltage regulator may be employed in this fashion, the invention is not limited in scope to this embodiment or to this particular transceiver application, as previously indicated. This particular embodiment, illustrated in FIG. 1, comprises a two output port, half-balanced, low AC impedance, power supply that acts as a current sink or source, featuring a high impedance mode for full speed signaling, although the invention is not limited in scope in this respect. The voltage regulator is illustrated as embodied on an integrated circuit (IC) chip, although the invention is not limited in scope in this respect. Referring to FIG. 1, input ports 110 and 120 form current mirrors when coupled with their counterparts from a constant current generator. In this embodiment, 120 should be sufficient to sink the current desired by the application plus reasonable “headroom,” although the invention is not limited in scope to this particular embodiment. In this embodiment, 110 should be sufficient current for mirroring to source followers 210 and 220, although, again, the invention is not limited in scope to this particular embodiment. The input signal BGVREG comprises in this embodiment a voltage reference from a constant voltage generator. The appropriate signal applied to control input port HI# switches the regulator to a high impedance state in this embodiment, when a high speed signaling mode is not desired.

This voltage regulator embodiment provides a relatively constant voltage level over a wide range of currents that may be both sinked and sourced, regardless of whether or not it is employed in a high speed signaling environment. For example, although the invention is not limited in scope in this respect, this embodiment may provide a 0.8 volt voltage bias. It is noted in this particular embodiment that the substantially predetermined voltage level maintained by the voltage regulator is determined substantially by an externally supplied voltage signal, in this case BGVREG. The output stage of the voltage regulator in this embodiment includes a current switch providing the capability for the voltage regulator to sink and source current. This current switch comprises transistors 330 and 340. Output ports BIASM and BIASP either sink or source current depending on the current flow, such as when data signals are being transmitted by the high speed transmitter, in one embodiment. Referring to, for example, the drivers shown in FIG. 2 of the aforementioned concurrently filed patent application, drivers to sink or source current to the voltage regulator are illustrated, although, of course, the invention is not limited in scope to this. The direction of the current provided to the voltage regulator externally, such as by the drivers previously described, effectively controls the direction of the current through the current switch, so that it, therefore, operates as a current switch via devices 330 and 340 with an arbitrary reference voltage of BGVREG, plus the gate-to-source voltage of transistors 210 and 220 and reduced by the gate-to-source voltage of transistors 310 and 320.

Since the voltage level at both input ports of the current switch are the same, the current is substantially free to switch from one side of the output stage to the other, as desired based on the current sinking or sourcing capability being externally provided. The voltage regulator may sink up to an amount of current set by the current source transistor 350. Devices 310 and 320 operate as low impedance source followers, providing a low impedance output port for the voltage regulator, although this output impedance varies as a function of the size of the output devices. Therefore, these source follower configurations provide current when the voltage regulator is sourcing current and they also provide “excess” current for the differential pair, 330 and 340.

Therefore, for the embodiment illustrated in FIG. 1, the current switch comprises two transistors coupled in a differential pair configuration, 330 and 340, further coupled to two transistors, such as 310 and 320, each of the two transistors being coupled in a source follower configuration. In an embodiment employing a driver, such as, for example, a transceiver, the source follower transistor configurations are employed to supply current to driver, where the voltage regulator is being employed in such a system, although, the voltage regulator, of course, operates in this manner without regard to the particular application. For example, without limitation, as described in the aforementioned concurrently filed patent application, a host computer and peripheral in communication may employ such a scheme. In such an application, however, which of the two source follower configurations is providing current to the electrically coupled, remote driver, depends at least in part on the direction of current flow.

For the embodiment illustrated in FIG. 1, 110 and 120 are coupled to bandgap circuits (not shown) that are externally provided. These bandgap circuits are applied to current mirrors that ultimately provide current to the current switch, as illustrated in FIG. 1. As previously discussed, the current switch includes the capability to have the direction switched of the current that is being sourced and sinked, the direction being determined at least in part by the direction of current supplied to the switch by an external source, as previously discussed.

The voltage regulator further includes the capability to switch between a high impedance and a low impedance mode based at least in part on an externally provided signal, as previously indicated. The voltage regulator is coupled so that the current switch operates when the voltage regulator is in a low impedance mode. In this embodiment, the voltage regulator is adapted to be coupled to a pair of external series impedances via BIASM and BIASP, although the invention is not limited in scope in this respect. In one potential environment, these external series impedances may operate as transmission line terminations, such as described in concurrently filed patent application Ser. No. ______ (attorney docket 042390.P6650), although, again, the invention is not limited in scope in this respect.

While certain features of the invention have been illustrated as described herein, many modifications, substitutions, changes and equivalents will now occur to those skilled in the art. It is, therefore, to be understood that the appended claims are intended to cover all such modifications and changes as fall within the true spirit of the invention.

What is claimed is:

1. An integrated circuit comprising:
a voltage regulator, said voltage regulator having the capability to both sink and source current while maintaining a substantially predetermined voltage level.

2. The integrated circuit of claim 1, wherein the voltage regulator further includes the capability to enter a high impedance mode in response to an applied external signal.

3. The integrated circuit of claim 2, wherein the voltage regulator is capable of maintaining an arbitrary substantially predetermined voltage level determined substantially by an externally supplied voltage signal.

4. The integrated circuit of claim 3, wherein said voltage regulator includes a current switch, the current switch providing said capability for said voltage regulator to both sink and source current.

5. The integrated circuit of claim 4, wherein said current switch comprises two transistors coupled in a differential pair configuration, said differential pair configuration being coupled to two other transistors, each of said two other transistors being coupled in a source follower configuration.

6. The integrated circuit of claim 5, wherein a plurality of current mirror transistor configurations are coupled to provide current for said current switch, said current mirrors being controlled at least in part by externally provided bandgap circuits.

7. The integrated circuit of claim 4, wherein said current switch includes the capability to have the direction switched of the current being sourced and sinked, the direction being determined at least in part by the direction of current supplied to the switch by an external source.

8. The integrated circuit of claim 4, wherein said voltage regulator is coupled so that said current switch operates when said voltage regulator is in the low impedance mode; said voltage regulator being further adapted to couple to a pair of external series impedances.

9. The integrated circuit of claim 8, wherein said voltage regulator is coupled to said pair of external series impedances, said external series impedances being coupled so as to operate as a transmission line termination.

10. A system comprising:
a driver to transmit data signals along a cable to a receiver, said driver being coupled to a voltage regulator, said voltage regulator having the capability to both sink and source current while maintaining a substantially predetermined voltage level.

11. The system of claim 10, wherein at least one of said driver and said receiver is incorporated into a host computer system.

12. The system of claim 11, wherein the voltage regulator further includes the capability to enter a high impedance mode in response to an applied signal.

13. The system of claim 12, wherein said voltage regulator includes a current switch, the current switch providing said capability for said voltage regulator to both sink and source current.

14. A method of both sinking and sourcing current while providing a substantially constant voltage level, said method comprising:
using a differential pair configuration as a current switch, the differential pair configuration being coupled to provide the substantially constant voltage level as an output signal, the differential pair configuration sinking current from an externally derived current source;
using at least one of a pair of source follower configurations to source current to the externally derived current source.

15. The method of claim 14, and further comprising: applying substantially the same voltage to each input port of the differential pair configuration.

16. The method of claim 14, wherein the substantially constant voltage level is determined at least in part by an externally derived voltage.

17. The method of claim 14, wherein the externally derived current source comprises an electrically coupled remote driver.
